(19) United States
(12) Patent Application Publication
(10) Pub. No.: US 2023/0327949 A1
(43) Pub. Date: Oct. 12, 2023

(54) ENDPOINT PERFORMANCE MONITORING MIGRATION BETWEEN REMOTE COLLECTORS

(71) Applicant: VMWARE, INC., Palo Alto, CA (US)

(72) Inventors: RAHUL SINGH, Varanasi (IN); Vinothkumar D, Villupuram (IN); Padmini Sampige Thirumalachar, Bangalore (IN); Vineeth Totappanavar, Bangalore (IN); Venkata Padma Kaki, West Godavari (IN)

(21) Appl. No.: 17/717,175

(22) Filed: Apr. 11, 2022

(51) Int. Cl. H04L 41/0813; H04L 67/00

(52) U.S. Cl. CPC H04L 41/0813; H04L 67/56; H04L 67/34

(57) ABSTRACT

An example computer-implemented method includes obtaining a migration script at a first compute node executing a first remote collector. The first remote collector may collect monitored information from an endpoint in a data center. Further, the migration script may be executed on the first compute node to copy a security artifact from the first remote collector to a second remote collector. The security artifact may provide a secure access to the endpoint. Upon copying the security artifact to the second remote collector, a first component of a data plane may be updated to send the monitored information to the second remote collector and a second component of a control plane may be updated to receive a control command from the second remote collector.

### TECHNICAL FIELD

The present disclosure relates to computing environments, and more particularly to methods, techniques, and systems for migrating endpoint performance monitoring from a first remote collector (e.g., associated with an on-premises platform) to a second remote collector (e.g., associated with the on-premises platform or a Software as a service (SaaS) platform).

### BACKGROUND

In application/operating system (OS) monitoring environments, a management node that runs a monitoring tool may communicate with multiple endpoints to monitor the endpoints. For example, an endpoint may be implemented in a physical computing environment, a virtual computing environment, or a cloud computing environment. Further, the endpoints may execute different applications via virtual machines (VMs), physical host computing systems, containers, and the like. In such environments, the management node may communicate with the endpoints to collect performance data/metrics (e.g., application metrics, operating system metrics, and the like) from underlying operating system and/or services on the endpoints for storage and performance analysis (e.g., to detect and diagnose issues).

### BRIEF DESCRIPTION OF THE DRAWINGS

FIG. 1 is a block diagram of an example system, depicting a management node to migrate monitoring of a plurality of endpoints from a first remote collector to a second remote collector;

FIGS. 2A-2C are block diagrams of an example data center, depicting migration of endpoint performance monitoring from a first remote collector to a second remote collector;

FIG. 3 is a sequence diagram illustrating a sequence of events to migrate endpoint performance monitoring from an on-premises platform to a cloud platform;

FIG. 4 is a flow diagram, illustrating an example method for migrating endpoint performance monitoring from a first remote collector to a second remote collector; and

FIG. 5 is a block diagram of an example management node including non-transitory computer-readable storage medium storing instructions to migrate endpoint performance monitoring from a first remote collector to a second remote collector.

The drawings described herein are for illustration purposes and are not intended to limit the scope of the present subject matter in any way.

### DETAILED DESCRIPTION

Examples described herein may provide an enhanced computer-based and/or network-based method, technique, and system to migrate monitoring of endpoints from a first remote collector that communicates with an on-premises' based monitoring application to a second remote collector that communicate with the on-premises' based monitoring application or a cloud-based monitoring application in a computing environment. Computing environment may be a physical computing environment (e.g., an on-premises enterprise computing environment or a physical data center), a virtual computing environment (e.g., a cloud computing environment, a virtualized environment, and the like), or a hybrid of both.

The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. The virtual computing environment may include multiple physical computers executing different workloads (e.g., virtual machines, containers, and the like). Such workloads may execute different types of applications.

The paragraphs [0010] to [0019] are an overview of endpoint performance monitoring in computing environments, existing methods to migrate the endpoint performance monitoring from one remote collector to another, and drawbacks associated with the existing methods. Performance monitoring of endpoints (e.g., physical host computing systems, virtual machines, software defined data centers (SDDCs), containers, and/or the like) has become increasingly important because performance monitoring may aid in troubleshooting (e.g., to rectify abnormalities or shortcomings, if any) the endpoints, provide better health of data centers, analyse the cost, capacity, and/or the like. An example performance monitoring tool or application or platform may be VMware® vRealize Operations (vROps), VMware Wavefront™, Grafana, and the like.

Further, the endpoints may include monitoring agents (e.g., Telegraf™, Collectd, Micrometer, and the like) to collect the performance metrics from the respective endpoints and provide, via a network, the collected performance metrics to a remote collector. Furthermore, the remote collector may receive the performance metrics from the monitoring agents and transmit the performance metrics to the monitoring tool for metric analysis. A remote collector may refer to a service/program that is installed in an additional cluster node (e.g., a virtual machine). The remote collector may allow the monitoring tool (e.g., vROps Manager) to gather objects into the remote collector's inventory for monitoring purposes. The remote collectors collect the data from the endpoints and then forward the data to the management node that executes the monitoring tool. For example, remote collectors may be deployed at remote location sites while the monitoring tool may be deployed at a primary location.

Furthermore, the monitoring tool may receive the performance metrics, analyse the received performance metrics, and display the analysis in a form of dashboards, for instance. The displayed analysis may facilitate in visualizing the performance metrics and diagnose a root cause of issues, if any. In some computing environments, the monitoring tools (e.g., vROps) may be deployed and run in on-premises platform to collect data from the endpoints via the remote collectors. The term “on-premises” may refer to a software and a hardware infrastructural setup (e.g., associated with the monitoring tools) deployed and running from within the confines of an organization/enterprise. In other computing environments, the monitoring tools (e.g., vROps) may be deployed and run-in cloud platforms (e.g., Software as a service (SaaS) platforms) to collect data from the endpoints via cloud proxies. The SaaS is a software distribution model in which a cloud provider hosts applications and makes the applications available to end users over the Internet. Cloud computing and Software as a service (SaaS) offers a plethora of advantages over the on-premises environment, viz. replacing capital expenditures with operating expenses, no upfront costs, subscription-based pricing, and the like.

The cloud computing and SaaS have changed software consumption, software development, and support processes. This is due to the fact that in a SaaS model, the software applications (e.g., the monitoring tools) are hosted by a service provider and/or a vendor and may not be deployed on customer's premises. This delivery model may be considered as an enabler for a different approach to software development and support users. Hence, customers may have to be provided with a hassle-free approach of application performance monitoring migration from the on-premises platform to the SaaS platform.

In an example on-premises platform, an application remote collector (ARC) is a type of remote collector that the monitoring tool (e.g., vROps) uses to collect metrics of applications running in endpoints (e.g., virtual machines) using monitoring agents. In an example SaaS platform, a cloud proxy is a type of remote collector that the monitoring tool (e.g., vROps) uses to collect metrics of applications running in endpoints (e.g., virtual machines) using monitoring agents. However, the ARC and cloud proxy are two different virtual appliances running on different versions of operating systems (e.g., Photon Operating Systems). For example, the ARC may run on Photon operating system version 1.0 whereas the cloud proxy may run on Photon operating system version 3.0. Further, components such as file server, data plane, and message receivers are different in both the virtual appliances.

In the example on-premises platform, the ARC includes a data plane provided by Erlang message queueing telemetry transport (Erlang MQTT message Broker or EMQTT) via a MQTT Protocol and a control plane provided via Salt (e.g., a configuration management and orchestration tool). In such an example on-premises platform, each endpoint may host a monitoring agent (e.g., a Telegraf agent) for metric collection, a service discovery agent (e.g., a universal communications platform (UCP) minion agent) for service discovery, and a configuration manager (e.g., a Salt minion) for control actions. The Telegraf agent and the UCP minion agent of the data plane may publish metrics to the EMQTT message broker running in the ARC. Further, the Salt minion of the control plane may communicate with a Salt master running in the ARC. Further, control commands such as updating the agents, starting/stopping the agents, and the like may be carried out via the Salt minions upon the request of the Salt master.

In the example SaaS platform, the cloud proxy includes a data plane provided by an Apache HTTPD web server via hypertext transfer protocol secure (HTTPS) protocol and a control plane provided via Salt. In such an example SaaS platform, each endpoint may host a monitoring agent (e.g., Telegraf Agent) for metric collection, a UCP minion agent for service discovery, and a Salt minion for control actions. Further, the Telegraf agent and the UCP minion of the data plane may publish metrics to the Apache HTTPD web server running in the cloud proxy. Furthermore, the Salt minion of the control plane may communicate with the Salt master running in the ARC. Further, control commands such as updating the agents, starting/stopping the agents, and the like may be performed via the Salt minions upon the request of the Salt master.

Application performance monitoring migration from the on-premises platform to the SaaS platform may provide advantages such as automatically upgrading cloud proxies to a compatible cluster version after the cluster upgrade. To achieve the performance monitoring migration from the on-premises platform to the SaaS platform, the endpoints may have to send the metrics to the cloud proxy instead of sending the metrics to the ARC. To perform the migration, the data plane may have to be changed. Also, in order to run control commands, the endpoint's Salt minion (i.e., currently communicating with the Salt master on the ARC) may have to connect to the Salt master on the cloud proxy (i.e., the control plane may have to be changed).

In some existing methods, the data plane and the control plane may be changed by manually changing the configuration of the endpoints. However, manually changing the configuration of the endpoints can be a cumbersome process and affect the user experience. In other existing methods, the user may have to reinstall and reconfigure the endpoints. However, reinstalling and reconfiguring the endpoints may not be feasible as an application administrator (e.g., an administrator responsible for viewing and managing user permissions in an application, adding and configuring applications, assigning applications to end users, and creating users) is different from an infrastructure administrator (i.e., an administrator responsible for configuring and managing cloud computing virtualization platform). Any reconfiguration of the endpoints may again require co-ordination between different departments, which the customers are wary about as the customers have to provide passwords again to reinstall/reconfigure the agents.

An yet another existing method to migrate the performance monitoring from the on-premises platform to the cloud platform may include a “start from scratch” approach, where both the remote collector and the monitoring agents on the endpoints (e.g., virtual machines) undergo a fresh/new installation. However, this approach may result in a potential loss of historical data that can occur due to fresh installation of the monitoring agents. This approach may also result in a downtime in monitoring incurred to perform the fresh installation of the remote collector and the monitoring agents.

Examples described herein may provide a management node to seamlessly migrate endpoint performance monitoring from a first remote collector (e.g., associated with an on-premises platform) to a second remote collector (e.g., associated with the on-premises platform or a cloud platform (e.g., a SaaS platform)). The management node may download a migration script to a first compute node, the first compute node executing a first remote collector (e.g., an ARC) to monitor a plurality of endpoints (e.g., virtual machines) and send monitored information to a first monitoring application. Further, the management node may execute the migration script on the first compute node to copy a security artifact from the first remote collector to a second remote collector (e.g., a cloud proxy). The security artifact may provide a secure access to the plurality of endpoints. Upon copying the security artifact to the second remote collector, the management node may update a data plane and a control plane of the plurality of endpoints and the cloud proxy to migrate monitoring of the endpoints from the first remote collector to the second remote collector.

Thus, examples described herein may utilize a single migration script to seamlessly migrate performance monitoring of the plurality of endpoints from the ARC to the cloud proxy with a minimum or no downtime and with no loss of historic data. Further, the endpoints being monitored by the ARC can be brought to a same state at the cloud proxy as was in the ARC, i.e., same agent configurations as was in the ARC. Examples described herein may enable agents, connected to the ARC before the migration, to start sending metrics to the cloud proxy after the migration without any manual operation at each endpoint. Furthermore, examples described herein may provide an approach which can be emulated wherever the data-plane and the control-plane need to be changed from one appliance (e.g., a compute node or virtual machine) to another.

In the following description, for purposes of explanation, numerous specific details are set forth to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

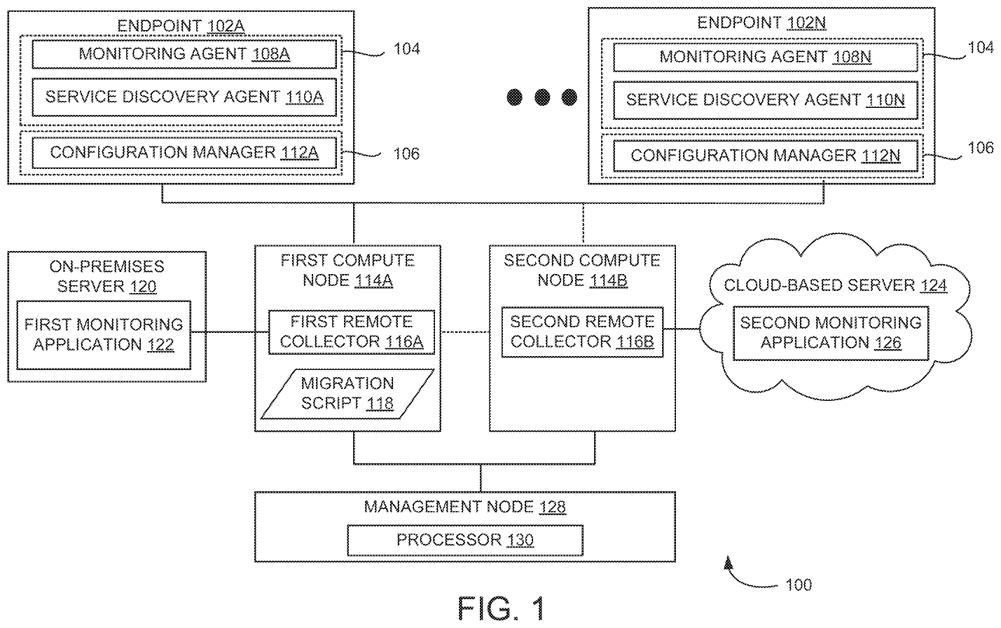

FIG. 1 is a block diagram of an example system 100, depicting a management node 128 to migrate monitoring of a plurality of endpoints 102A-102N from a first remote collector 116A to a second remote collector 1168. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

As shown in FIG. 1, example system 100 may be a data center that includes multiple endpoints 102A-102N. In an example, an endpoint may include, but not limited to, a virtual machine, a physical host computing system, a container, a software defined data center (SDDC), or any other computing instance that executes different applications. For example, the endpoint can be deployed either in an on-premises platform or an off-premises platform (e.g., a cloud managed SDDC). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of host operating system without the need for the hypervisor or separate operating system.

Further, endpoints 102A-102N may include corresponding monitoring agents 108A-108N to monitor respective endpoints 102A-102N. In an example, monitoring agent 108A may be installed in endpoint 102A to fetch the metrics from various components of endpoint 102A. For example, monitoring agent 108A may real-time monitor endpoint 102A to collect the metrics (e.g., telemetry data) associated with an application or an operating system running in endpoint 102A. Example monitoring agent 108A may be Telegraf agent, Collectd agent, or the like. Example metrics may include performance metric values associated with at least one of central processing unit (CPU), memory, storage, graphics, network traffic, or the like.

Further, system 100 may include a first compute node 114A and a second compute node 1148. An example compute node may include, but not limited to, a virtual machine, a physical host computing system, a container, or any other computing instance. In an example, first compute node 114A executes first remote collector 116A (e.g., an application remote collector (ARC)) to monitor plurality of endpoints 102A-102N. First remote collector 116A may send monitored information associated with endpoints 102A-102N to a first monitoring application 122. For example, first remote collector 116A may receive the metrics (e.g., performance metrics) from monitoring agent 108A of endpoint 102A. Further, first remote collector 116A may transmit the received metrics to first monitoring application 122 running in an on-premises server 120. Furthermore, second compute node 114B executes a second remote collector 116B (e.g., a cloud proxy). Second remote collector 116B may be associated with first monitoring application 122 or a second monitoring application 126 (e.g., a SaaS application). Example second monitoring application 126 may run in a cloud-based server 124. First remote collector 116A and second remote collector 116B are deployed in the same data center as endpoints 102A-102N on which monitoring agents 108A-108N are deployed.

Furthermore, example system 100 includes management node 128 to manage the data center. For example, management node 128 may execute centralized management services that may be interconnected to manage the resources centrally in the virtualized computing environment. Example centralized management service may be enabled by vCenter Server™ and vSphere® program products, which are VMware's cloud computing virtualization platforms. In an example, management node 128 may be communicatively connected to the data center via a network to manage the data center. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 128 may include a processor 130. Processor 130 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 130 may, for example, include single or multiple cores on a chip, multiple cores across multiple chips, multiple cores across multiple devices, or suitable combinations thereof. Processor 130 may be functional to fetch, decode, and execute instructions as described herein.

During operation, processor 130 may receive a request to migrate endpoint performance monitoring from first remote collector 116A to second remote collector 116B. In an example, the request is to migrate the endpoint performance monitoring from the ARC to the cloud proxy within an on-premises platform (i.e., first monitoring application 122). In this example, both first remote collector 116A and second remote collector 116B may communicate with the on-premises platform. In another example, the request is to migrate the endpoint performance monitoring from the ARC to the cloud proxy between different monitoring platforms. In this example, first remote collector 116A may communicate with the on-premises platform (i.e., first monitoring application 122) and second remote collector 1168 may communicate with the SaaS platform (i.e., second monitoring application 126), as shown in FIG. 1.

To migrate the endpoint performance monitoring from first remote collector 116A to second remote collector 1168, processor 130 may download a migration script 118 to first compute node 114A. In an example, processor 130 may download migration script 118 from second compute node 1148 or from an external server. Further, processor 130 may execute migration script 118 on first compute node 114A. Migration script 118, when executed, may copy a security artifact from first remote collector 116A to second remote collector 1168. In an example, the security artifact provides a secure access to plurality of endpoints 102A-102N. An example security artifact can be a key, a certificate, a credential, a token, an authorization policy, an audit policy, or any combination thereof.

Upon copying the security artifact to second remote collector 1168, migration script 118, when executed, updates a first component of a data plane 104 and a second component of a control plane 106 of each of endpoints 102A-102N to migrate monitoring of endpoints 102A-102N from first remote collector 116A to second remote collector 1168. As used herein, a data plane refers to software, hardware, firmware, or a combination thereof that performs packet processing logic such as load balancing, security, and the like. A control plane refers to software, hardware, firmware, or a combination thereof that performs management and control functions such as provisioning, creating, and modifying policies for network services, coordinating with service engines and virtualization infrastructure, monitoring endpoints, statistics generation and analysis, interactions with user applications, and the like.

For example, components (e.g., the first component) of data plane 104 may include monitoring agents 108A-108N, service discovery agents 110A-110N, or both. Further, components (e.g., the second component) of control plane 106 may include configuration managers 112A-112N. In an example, processor 130 may update configuration manager 112A of control plane 106 to map to second remote collector 116B to listen to the control command, for instance, from a configuration master running in second remote collector 116B. The configuration master (e.g., a Salt master) is a server that acts as a command-and-control center for configuration managers 112A-112N (e.g., Salt minions), from where Salt's remote execution commands are executed. For example, the Salt minion performs installation of monitoring agents 108A-108N, sets up the operating system input plugins, configuration updates, remote command executions, and the like.

Further, processor 130 may update service discovery agents 110A-110N of data plane 104 to discover services running in respective endpoints 102A-102N and send service discovery data associated with the discovered services to second remote collector 1168. The service discovery may help to determine type of services running in each of endpoints 102A-102N in the computing environment. In an example, the service discovery may help to discover services running in each of endpoints 102A-102N and then build a relationship or dependency between the services from different endpoints 102A-102N.

Furthermore, processor 130 may update monitoring agents 108A-108N of data plane 104 to communicate with second remote collector 1168 to transmit the monitored information to second remote collector 116B. For example, application monitoring tools may deploy monitoring agents 108A-108N (e.g., in-guest agents) on endpoints 102A-102N to collect application-level data and/or metrics from respective endpoints 102A-102N and pass the collected data and/or metrics to monitoring application 122 or 126 for analysis and troubleshooting endpoints 102A-102N.

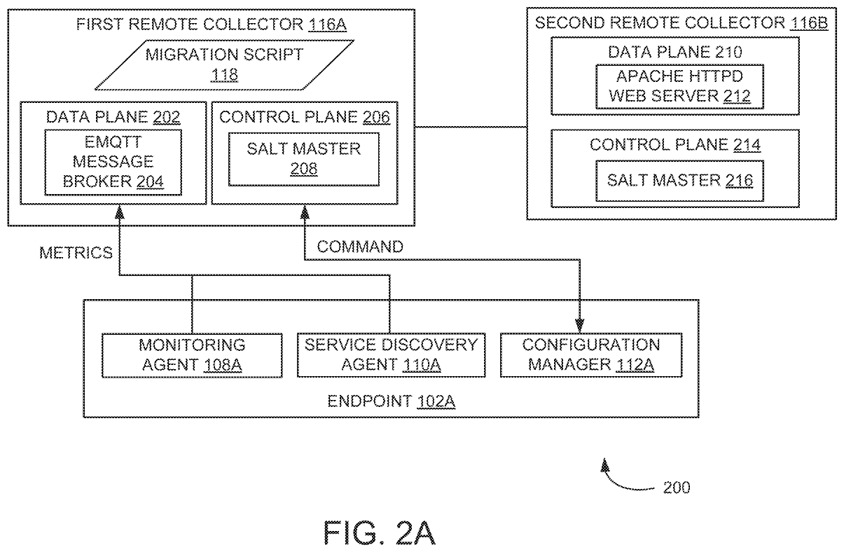

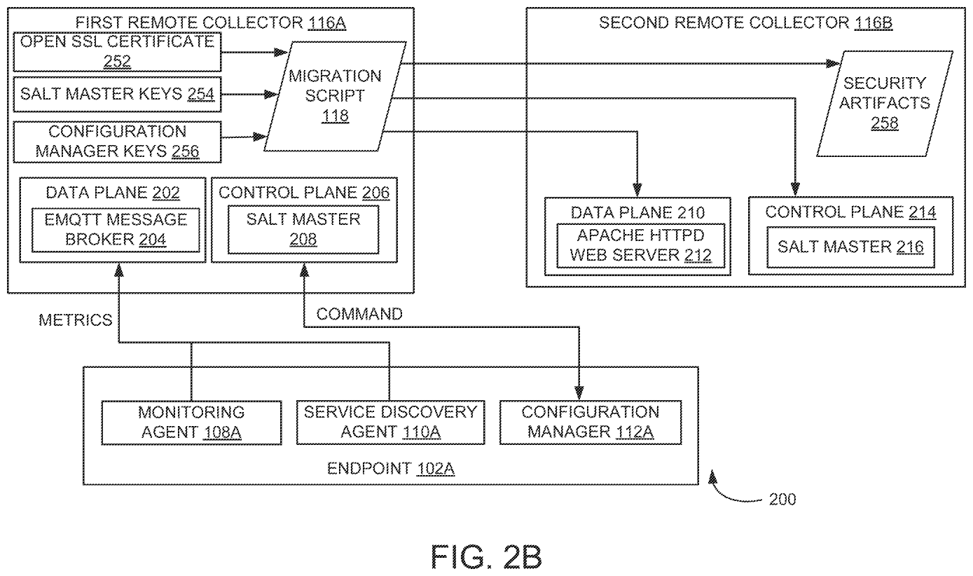

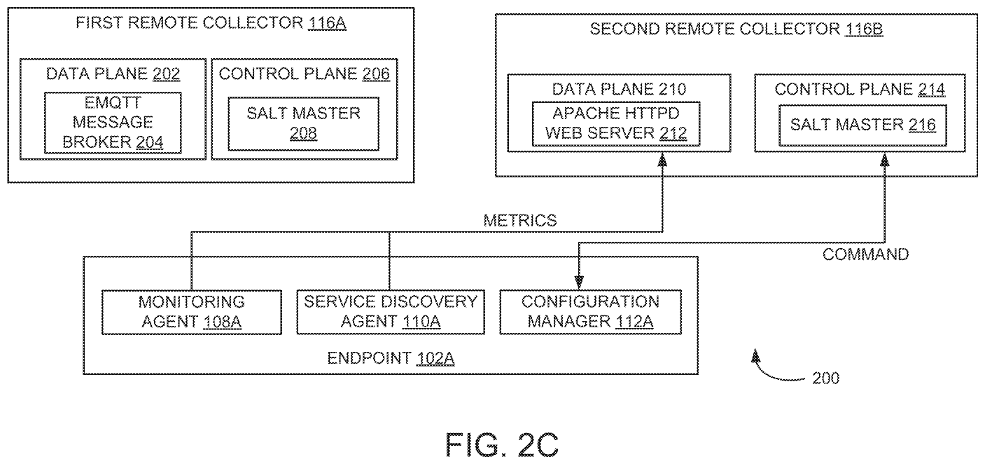

Upon updating the first component of data plane 104 and the second component of control plane 106, processor 130 may reboot or restart the first component of each of endpoints 102A-102N to send the monitored information to second remote collector 1168 and reboot the second component of each of endpoints 102A-102N to receive the control command from second remote collector 116B. An example migration from first remote collector 116A to second remote collector 116B is described in FIGS. 2A to 2C.

Further, second remote collector 1168 may collect performance metrics of the operating system and/or applications associated with endpoints 102A-102N in runtime. Further, second remote collector 1168 may transmit the performance metrics to first monitoring application 122 or second monitoring application 126 via the network for monitoring and troubleshooting endpoints 102A-102N. Even though FIG. 1 depicts first remote collector 116A as being in communication with first monitoring application 122 and second remote collector 116B as being in communication with second monitoring application 126, examples described herein can also be implemented in a scenario where both first remote collector 116A and second remote collector 1168 are in communication with first monitoring application 122.

Thus, examples described herein provide migration script 118 that uses an existing control channel to trigger the changes on endpoints 102A-102N so that data plane 104 changes from first remote collector 116A (i.e., the ARC) to second remote collector 116B (e.g., the cloud proxy). Further, control plane 106 may also change itself from pointing to the ARC to the cloud proxy. Further, with the examples described herein, without any explicit operation performed by a user at each endpoint for migration, monitoring agents 108A-108N that send metrics to the ARC can begin to send metrics to the cloud proxy after the migration. In some examples, when the migration of performance monitoring for any endpoint fails, migration script 118 may rerun and retry to migrate only endpoints which were left to be migrated.

FIGS. 2A-2C are block diagrams of an example data center 200, depicting migration of endpoint performance monitoring from a first remote collector 116A (e.g., an ARC) to a second remote collector 116B (e.g., a cloud proxy). First remote collector 116A may communicate with an on-premises' based monitoring application and second remote collector 116B may communicate with the on-premises'based monitoring application or a cloud-based monitoring application (e.g., a SaaS platform).

FIG. 2A shows a block diagram of example data center 200, depicting first remote collector 116A monitoring the application performance of an endpoint 102A. For example, similarly named elements of FIG. 2A may be similar in structure and/or function to elements described with respect to FIG. 1. As shown in FIG. 2A, example data center 200 includes first remote collector 116A, second remote collector 1168, and endpoint 102A. First remote collector 116A and second remote collector 116B may run in separate compute nodes or virtual appliances (e.g., virtual machines).

For example, first remote collector 116A may be an ARC, which runs on Photon operating system version 1.0. Further, first remote collector 116A may include a data plane 202 and a control plane 206. For example, data plane 202 is provided by a EMQTT message broker 204 (e.g., via MQTT Protocol) and control plane 206 is provided via Salt master 208. EMQTT message broker 204 and Salt master 208 may run as docker containers on a first compute node (e.g., first compute node 114A of FIG. 1). Second remote collector 1168 can be a cloud proxy, which may run on Photon operating system version 3.0. Further, second remote collector 116B may include a data plane 210 and a control plane 214. For example, data plane 210 is provided by an Apache HTTPD web server 212 and control plane 214 is provided via Salt master 216. Apache HTTPD web server 212 may run as a service on a second compute node (e.g., second compute node 114B of FIG. 1). Furthermore, endpoint 102A may include a monitoring agent 108A (e.g., a Telegraf agent) to collect metrics, a service discovery agent 110A (e.g., a UCP minion agent) for service discovery, and a configuration manager 112A (e.g., a Salt minion) for control actions.

In some examples, first remote collector 116A and second remote collector 1168 use OpenSSL certificates and keys to secure endpoint communications (e.g., metric communications). Further, first remote collector 116A and second remote collector 116B may use Salt for control plane activities on endpoint 102A. The Salt may use a server-agent communication model, where a server component is referred as Salt master 208 and an agent is referred as the Salt minion (i.e., configuration manager 112A). Salt master 208 and the Salt minion may secure communication through Salt master keys and Salt minion keys generated at the compute nodes on which first remote collector 116A and second remote collector 116B are resided. A Salt state may be applied from Salt master 208 to the Salt minion to apply control commands on endpoint 102A.

In the example shown in FIG. 2A, monitoring agent 108A and service discovery agent 110A may publish metrics to EMQTT message broker 204 residing in first remote collector 116A. Further, configuration manager 112A may communicate with Salt master 208 residing in first remote collector 116A. The control commands such as update agents, start agents, stop agents, and the like may be carried out via configuration manager 112A at a request of Salt master 208.

In an example, migration script 118 may be downloaded at first remote collector 116A. For example, migration script 118 may be downloaded from a compute node (e.g., second compute node 114B as shown in FIG. 1) that executes second remote collector 116B. Further, migration script 118, when executed, performs a series of processes to migrate endpoint performance monitoring from first remote collector 116A to second remote collector 116B as described in FIG. 2B.

FIG. 2B shows a block diagram of example data center 200 of FIG. 2A, depicting copying of security artifacts 258 from first remote collector 116A to second remote collector 116B. In an example, upon downloading migration script 118, migration script 118 with a command line argument may be executed as a one-time activity for migration of endpoints (e.g., endpoints 102A-102N of FIG. 1) being monitored by first remote collector 116A to second remote collector 116B.

In an example, upon executing migration script 118, the following steps are performed:
Copy security artifacts 258 from first remote collector 116A to second remote collector 116B. For example, security artifacts 258 includes an OpenSSL certificate 252, Salt master keys 254, and configuration manager keys 256.
Upgrade configuration manager 112A running in endpoint 102A. In an example, a configuration file of configuration manager 112A may be updated to add a destination Internet protocol (IP) address of second remote collector 116B, a destination storage location of second remote collector 1168, or a combination thereof.
Upgrade service discovery agent 110A running in endpoint 102A. For example, UCP minion libraries may be downloaded at endpoint 102A and service discovery agent 110A may be updated using the UCP minion libraries and service discovery agent 110A may be restarted to send service discovery metrics to second remote collector 1168.
Upgrade monitoring agent 108A (e.g., Telegraf agent) running in endpoint 102A. In this example, application metrics publish path may be updated at endpoint 102A and monitoring agent 108A may be restarted to send the application metrics/performance metrics to second remote collector 1168.
Restart the configuration manager to start receiving control commands from second remote collector 1168.

FIG. 2C shows example data center 200 of FIG. 2A, depicting endpoint 102A being monitored by second remote collector 1168 after the migration. Upon migrating application performance monitoring from first remote collector 116A to second remote collector 1168, monitoring agent 108A and service discovery agent 110A may publish metrics to Apache HTTPD web server 212 residing in second remote collector 1168. Further, configuration manager 112A may communicate with Salt master 216 running in second remote collector 116B. Furthermore, the control commands such as update agents, start agents, stop agents, and the like may be carried out via configuration manager 112A at a request of Salt master 216. Thus, examples described herein may be used for moving the control plane and the data plane between any two appliances (e.g., virtual machines).

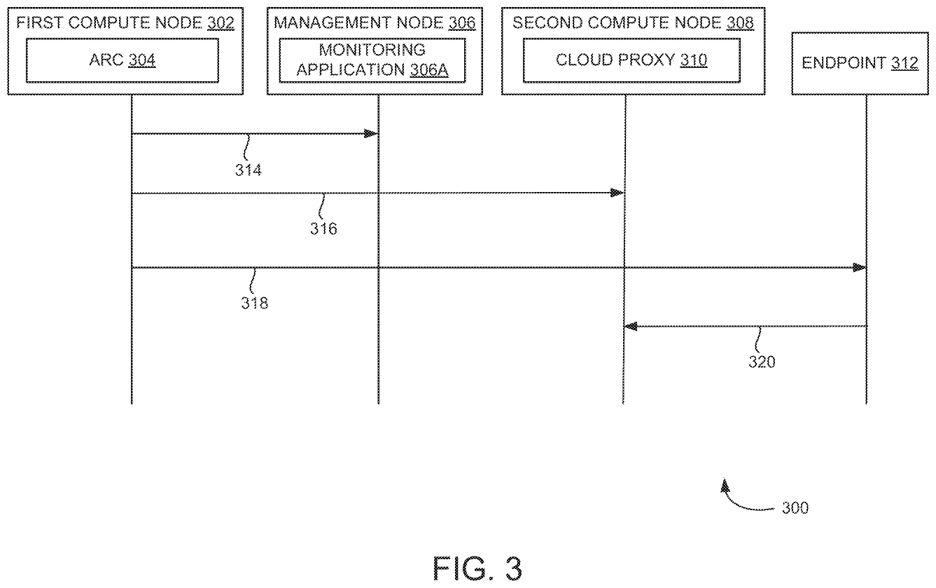

FIG. 3 is a sequence diagram 300 illustrating a sequence of events to migrate endpoint performance monitoring from an on-premises platform to a cloud platform (e.g., a Software as a service (SaaS) platform). Sequence diagram 300 may represent interactions and operations involved in migrating the endpoint performance monitoring from an ARC 304 to a cloud proxy 310 to monitor an endpoint 312. FIG. 3 illustrates process objects including a first compute node 302 executing ARC 304, a management node 306 (e.g., enabled by vCenter Server®, VMware's centralized management platform), a second compute node 308 executing cloud proxy 310, and endpoint 312 along with their respective vertical lines originating from them. The vertical lines of first compute node 302, management node 306, second compute node 308, and endpoint 312 may represent the processes that may exist simultaneously. The horizontal arrows (e.g., 314, 316, 318, and 320) may represent the process/sequence flow steps between the vertical lines originating from their respective process objects (for e.g., first compute node 302, management node 306, second compute node 308, and endpoint 312).

In this example, endpoint 312 may be a virtual machine running on a host computing system. An example host computing system can be an enterprise-class type-1 (ESXi) hypervisor executing multiple virtual machines. Further, ARC 304 may communicate with endpoint 312 to collect performance metrics and transmit the metrics to an on-premises-based monitoring application 306A (e.g., vROps) for analysis. In an example, the on-premises-based monitoring application 306A can be implemented as part of management node 306. In the examples described herein, management node 306 may migrate application performance monitoring from the on-premises platform to the cloud platform (e.g., using the processes depicted in 314, 316, 318, and 320).

At 314, an existing adapter (e.g., an AppOS adapter) for ARC-vCenter pair may be deleted and an adapter for cloud proxy-vCenter pair may be created, for instance, at on-premises-based monitoring application 306A. At 316, security artifacts may be copied from ARC 304 to cloud proxy 310. For example, the secure artifacts include OpenSSL certificates (e.g., for secure data-plane activities), salt master keys, and salt minion keys (e.g., for secure control-plane activities). Further, a Salt master docker and an Apache HTTPD service may be restarted at cloud proxy 310.

At 318, a Salt command may be executed to update a control-plane and a data-plane of endpoint 312 to map endpoint 312 to cloud proxy 310. For example, updating the control-plane and the data-plane include:
Upgrading a configuration manager: A Salt state may be applied at endpoint 312 from a Salt master at ARC 304 to update a configuration file of a Salt minion. Further, a https metric publish path, a https server URL, and a download URL of second compute node 308 may be added as properties to the configuration manager to be used by other supporting agents. Furthermore, Salt master FQDN configured at endpoint 312 may be updated from ARC 304 to cloud proxy's FQDN, to change control plane from ARC 304 to cloud proxy 310. The “download URL” may refer to file server address of ARC or cloud proxy appliance where bits and configuration related to the agents are hosted which are downloaded by endpoints during agent installations and data operations. The “Https server URL” may refer to an URL of the cloud proxy appliance, which can be used in conjunction with different http endpoints to post metrics to httpd Apache service at cloud proxy 310.
Upgrading a supporting agent: A Salt state may be executed at endpoint 312 to download and update the UCP-minion (e.g., the supporting agent) libraries. The UCP-minion may be responsible for sending service discovery (e.g., services/application discovered on endpoints) and health metrics of other agents (e.g., the configuration manager and monitoring agent) to cloud proxy 310. The UCP-minion may use configuration manager properties, https metric publish path, and https server URL to post metrics to second compute node 308. Furthermore, the UCP-minion service may be restarted to start sending the service discovery and health metrics of endpoint 312 to cloud proxy 310.
Upgrading a monitoring agent: A Salt state may be executed at endpoint 312 to update configuration of the monitoring agent (e.g., Telegraf agent). In this example, the Telegraf uses metrics publish path in Telegraf configuration to post metrics to cloud proxy 310. Thus, the metrics publish path may be updated to cloud proxy's https URL and Telegraf service may be restarted to start sending application metrics to cloud proxy 310.
Restarting a configuration manager: A Salt state may be executed at endpoint 312 to restart the salt minion to start receiving control commands from cloud proxy 310.

At 320, upon migration, cloud proxy 310 may collect the metrics from endpoint 312 and transmit the metrics to the cloud platform. Thus, examples described herein may reduce the burden of manual interventions or reinstall of agents to migrate application performance monitoring from ARC 304 to cloud proxy 310 during an on-premises to on-premises migration or on-premises to SaaS migration.

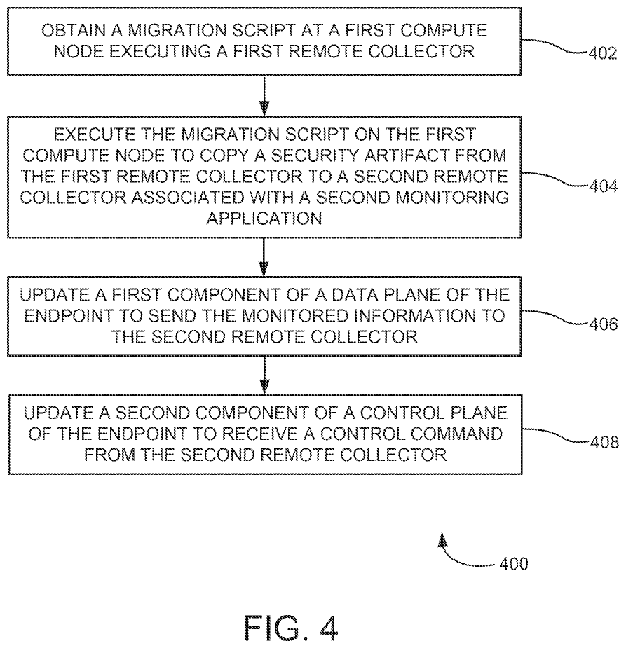

FIG. 4 is a flow diagram 400, illustrating an example method for migrating endpoint performance monitoring from a first remote collector to a second remote collector. The process depicted in FIG. 4 represents generalized illustrations, and other processes may be added, or existing processes may be removed, modified, or rearranged without departing from the scope and spirit of the present application. In addition, the process may represent instructions stored on a computer-readable storage medium that, when executed, may cause a processor to respond, to perform actions, to change states, and/or to make decisions. Alternatively, the process may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but rather the flow chart illustrates functional information to design/fabricate circuits, generate machine-readable instructions, or use a combination of hardware and machine-readable instructions to perform the illustrated process.

At 402, a migration script may be obtained at a first compute node executing a first remote collector. In an example, obtaining the migration script at the first compute node includes downloading the migration script from a second compute node executing the second remote collector to the first compute node of the first remote collector. For example, the first remote collector collects monitored information from an endpoint in a data center and sends the monitored information to a first monitoring application. The first remote collector may act as an application remote collector (ARC) to communicate with the first monitoring application running in a on-premises server and the second remote collector acts as a cloud proxy to communicate with the first monitoring application or a second monitoring application running in a cloud-based server.

At 404, the migration script may be executed on the first compute node to copy a security artifact from the first remote collector to the second remote collector. In an example, the security artifact provides a secure access to the endpoint. For example, the security artifact can be a key, a certificate, a credential, a token, an authorization policy, an audit policy, or any combination thereof.

At 406, upon copying the security artifact to the second remote collector, the migration script may be executed on the first compute node to update a first component of a data plane of the endpoint to send the monitored information to the second remote collector. In an example, updating the first component of the data plane includes updating a service discovery agent in the endpoint to discover services running in the endpoint and send service discovery data associated with the discovered services to the second remote collector. In another example, updating the first component of the data plane includes updating a monitoring agent running in the endpoint to communicate with the second remote collector to transmit the monitored information to the second remote collector.

At 408, upon copying the security artifact to the second remote collector, the migration script may be executed on the first compute node to update a second component of a control plane of the endpoint to receive a control command from the second remote collector. In an example, updating the second component of the control plane may include updating a configuration manager in the endpoint to map to the second remote collector to listen to the control command. In an example, updating the configuration manager comprises updating configuration data of the configuration manager to add a destination Internet protocol (IP) address of the second remote collector, destination storage location of the second remote collector, or both. In this example, updating the configuration manager includes replacing the IP address of the first remote collector with an IP address of the second remote collector.

Upon updating the first component of the data plane and the second component of the control plane, the migration script may be executed on the first compute node to reboot the first component to send the monitored information to the second remote collector and reboot the second component to receive the control command from the second remote collector. Further, the first remote collector may be deactivated upon enabling the second remote collector to monitor the endpoint.

Further, performance metrics of the operating system and/or applications associated with the endpoint may be collected by the second remote collector in runtime. Furthermore, the performance metrics may be transmitted to the first monitoring application or the second monitoring application via a network for monitoring and troubleshooting the endpoint. In an example, the performance metrics may be received by the first monitoring application or the second monitoring application from the second remote collector via the network. Further, a performance analysis of the endpoint may be performed by the first monitoring application or the second monitoring application using the received performance metrics.

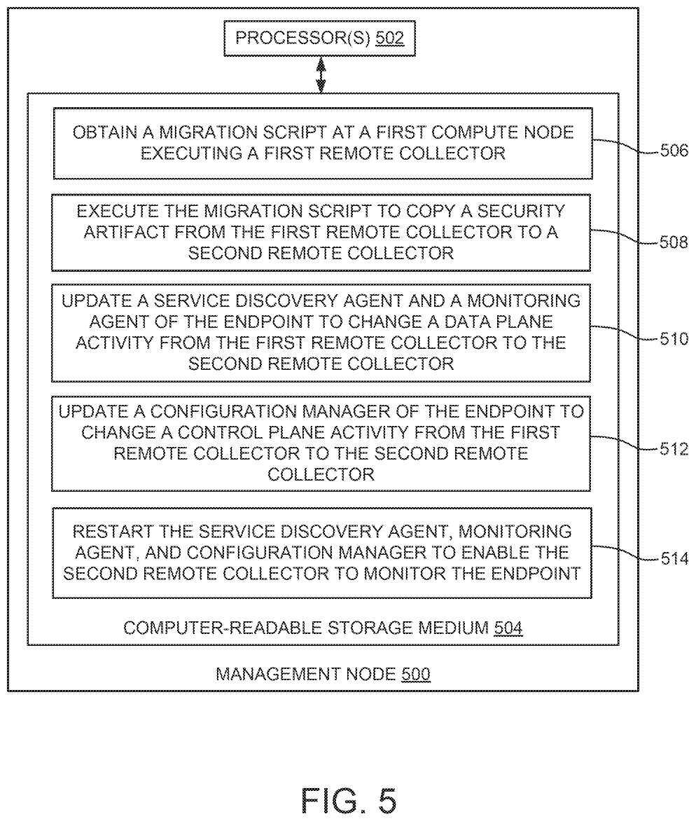

FIG. 5 is a block diagram of an example management node 500 including non-transitory computer-readable storage medium 504 storing instructions to migrate endpoint performance monitoring from a first remote collector to a second remote collector. Management node 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 504 may be a non-transitory machine-readable medium. In an example, machine-readable storage medium 504 may be remote but accessible to management node 500.

Machine-readable storage medium 504 may store instructions 506, 508, 510, 512, and 514. Instructions 506 may be executed by processor 502 to obtain a migration script at a first compute node executing a first remote collector. The first remote collector may collect monitored information from an endpoint. An example endpoint may be a physical host computing system, a virtual machine, a container, a software defined data center (SDDC), or any combination thereof. Further, the first remote collector may communicate with a first monitoring application running in an on-premises server.

Instructions 508 may be executed by processor 502 to execute the migration script to copy a security artifact from the first remote collector to a second remote collector. The second remote collector may communicate with the first monitoring application running in the on-premises server or a second monitoring application running in a cloud-based server. Instructions 510 may be executed by processor 502 to execute the migration script to update a service discovery agent and a monitoring agent of the endpoint to change a data plane activity from the first remote collector to the second remote collector. The service discovery agent may communicate service discovery data and the monitoring agent may communicate performance metrics. In an example, instructions 510 to update the service discovery agent include instructions to update the service discovery agent in the endpoint to discover services running in the endpoint and send the service discovery data associated with the discovered services to the second remote collector. Further, instructions 510 to update the monitoring agent may include instructions to update the monitoring agent running in the endpoint to communicate with the second remote collector to transmit the performance metrics to the second remote collector.

Instructions 512 may be executed by processor 502 to execute the migration script to update a configuration manager of the endpoint to change a control plane activity from the first remote collector to the second remote collector. In an example, instructions 512 to update the configuration manager include instructions to update configuration data of the configuration manager to receive a control command from the second remote collector. The control command is to perform an activity on the endpoint.

Instructions 514 may be executed by processor 502 to execute the migration script to restart the service discovery agent, monitoring agent, and configuration manager to enable the second remote collector to monitor the endpoint.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

1. A computer-implemented method comprising:
obtaining a migration script at a first compute node executing a first remote collector, wherein the first remote collector is to collect monitored information from an endpoint in a data center; and
executing the migration script on the first compute node to:
copy a security artifact from the first remote collector to a second remote collector running in a second compute node, wherein the security artifact is to provide a secure access to the endpoint; and
upon copying the security artifact to the second remote collector,
update a first component of a data plane of the endpoint to send the monitored information to the second remote collector; and
update a second component of a control plane of the endpoint to receive a control command from the second remote collector.

2. The computer-implemented method of claim 1, further comprising:
upon updating the first component of the data plane and the second component of the control plane, rebooting the first component to send the monitored information to the second remote collector and rebooting the second component to receive the control command from the second remote collector.

3. The computer-implemented method of claim 1; wherein updating the second component of the control plane comprises:
updating a configuration manager in the endpoint to map to the second remote collector to listen to the control command.

4. The computer-implemented method of claim 3, wherein updating the configuration manager comprises updating configuration data of the configuration manager to add a destination Internet protocol (IP) address of the second remote collector, destination storage location of the second remote collector, or both.

5. The computer-implemented method of claim 3, wherein updating the configuration manager comprises:
replacing an Internet protocol (IP) address of the first remote collector with an IP address of the second remote collector.

6. The computer-implemented method of claim 1, wherein updating the first component of the data plane comprises:
updating a monitoring agent running in the endpoint to communicate with the second remote collector to transmit the monitored information to the second remote collector.

7. The computer-implemented method of claim 1, wherein updating the first component of the data plane comprises:
updating a service discovery agent in the endpoint to discover services running in the endpoint and send service discovery data associated with the discovered services to the second remote collector.

8. The computer-implemented method of claim 1, wherein the security artifact is a key, a certificate, a credential, a token, an authorization policy, an audit policy, or any combination thereof.

9. The computer-implemented method of claim 1, further comprising:
deactivating the first remote collector upon enabling the second remote collector to monitor the endpoint.

10. The computer-implemented method of claim 1, wherein obtaining the migration script at the first compute node comprises:
downloading the migration script from the second compute node executing the second remote collector to the first compute node of the first remote collector.

11. The computer-implemented method of claim 1, wherein the first remote collector acts as an application remote collector to communicate with a first monitoring application running in a on-premises server and the second remote collector acts as a cloud proxy to communicate with the first monitoring application running in the on-premises server or a second monitoring application running in a cloud-based server.

12. A system comprising:
a plurality of endpoints;
a first compute node executing a first remote collector to monitor the plurality of endpoints and send monitored information associated with the plurality of endpoints to a first monitoring application;
a second compute node executing a second remote collector, wherein the second remote collector is associated with the first monitoring application or a second monitoring application; and
a management node communicatively connected to the first compute node and second compute node and comprising instructions executable by a processor to:
download a migration script to the first compute node; and
execute the migration script on the first compute node to:
copy a security artifact from the first remote collector to a second remote collector, wherein the security artifact is to provide a secure access to the plurality of endpoints; and
upon copying the security artifact to the second remote collector, update a first component of a data plane of each of the plurality of endpoints to send the monitored information to the second remote collector and update a second component of a control plane of each of the plurality of endpoints to receive a control command from the second remote collector.

13. The system of claim 12, wherein the processor is to:
upon updating the first component of the data plane and the second component of the control plane, reboot the first component to send the monitored information to the second remote collector and reboot the second component to receive the control command from the second remote collector.

14. The system of claim 12, wherein the processor is to:
update a configuration manager of the control plane to map to the second remote collector to listen to the control command.

15. The system of claim 12, wherein the processor is to:
update a monitoring agent of the data plane to communicate with the second remote collector to transmit the monitored information to the second remote collector.

16. The system of claim 12, wherein the processor is to:
update a service discovery agent of the data plane to discover services running in the endpoint and send service discovery data associated with the discovered services to the second remote collector.

17. A non-transitory computer-readable storage medium comprising instructions executable by a processor to:
obtain a migration script at a first compute node executing a first remote collector, wherein the first remote collector is to collect monitored information from an endpoint; and
execute the migration script to:
copy a security artifact from the first remote collector to a second remote collector;
update a service discovery agent and a monitoring agent of the endpoint to change a data plane activity from the first remote collector to the second remote collector, wherein the service discovery agent is to communicate service discovery data associated with discovered services running in the endpoint and the monitoring agent is to communicate performance metrics of the endpoint;
update a configuration manager of the endpoint to change a control plane activity from the first remote collector to the second remote collector; and
restart the service discovery agent, the monitoring agent, and the configuration manager to enable the second remote collector to monitor the endpoint.

18. The non-transitory computer-readable storage medium of claim 17, wherein instructions to update the configuration manager comprise instructions to:
update configuration data of the configuration manager to receive a control command from the second remote collector, the control command to perform an activity on the endpoint.

19. The non-transitory computer-readable storage medium of claim 17, wherein instructions to update the monitoring agent comprise instructions to:
update the monitoring agent running in the endpoint to communicate with the second remote collector to transmit the performance metrics to the second remote collector.

20. The non-transitory computer-readable storage medium of claim 17, wherein instructions to update the service discovery agent comprise instructions to:
update the service discovery agent in the endpoint to discover services running in the endpoint and send the service discovery data associated with the discovered services to the second remote collector.
